(19) United States
(12) Patent Application Publication
(10) Pub. No.: US 2026/0071394 A1
(43) Pub. Date: Mar. 12, 2026

(54) System and Method for Determining the State of Compaction

(71) Applicant: Caterpillar Paving Products Inc., Brooklyn Park, MN (US)

(72) Inventors: Nicholas A. Oetken, Brooklyn Park, MN (US); Brian D. Nagel, Ramsey, MN (US); Todd A. Impola, Delano, MN (US); Matthew T. Hanson, St. Louis Park, MN (US); Zachary J. Vrchota, Brooklyn Park, MN (US); Aaron Y. Ho, Naperville, IL (US)

(73) Assignee: Caterpillar Paving Products Inc., Brooklyn Park, MN (US)

(21) Appl. No.: 18/828,577

(22) Filed: Sep. 9, 2024

(51) Int. Cl. E01C 19/28; E01C 23/01; G01K 13/02; G01L 17/00

(52) U.S. Cl. CPC E01C 19/288; E01C 23/01; G01K 13/026; G01L 17/00

(57) ABSTRACT

A compaction measurement system is configured to measure the state of compaction of a work material by a rolling compactor. The compaction measurement system includes a powertrain sensor to measure the gross generated power produced by a powertrain of the rolling compactor and a temperature sensor to measure the temperature of a system associated with the rolling compactor. The compaction measurement system also includes an electronic controller that converts the system temperature to a temperature compensation factor and calculates an actual drive power applied during the compaction process from the temperature compensation factor and the gross generated power.

### TECHNICAL FIELD

The present disclosure relates generally to machines that compact material, and more particularly, to a system, method, and controller for determining a state of compaction of a work material at a worksite.

### BACKGROUND

Mobile compacting machines or rolling compactors are commonly used to compact aggregate work materials (such as soil, gravel, asphalt) to a desired density and hardness while constructing roadways, highways, parking lots, and other structures. In addition, compactors are often used to compact recently moved and/or relatively soft aggregate materials at mining sites and landfills to increase the firmness and reduce the volume of the materials. The rolling compactors may include one or more rotating cylindrical drums that can be rolled over the material so that the weight of the rolling compactor compresses the material into the denser, finished surface. The compaction process often requires several of passes of the mobile rolling compactor over the work material to reach a desired density and hardness.

Determining whether the desired level of compaction has been reached may be estimated in a variety of manners. In some instances, the compaction may be approximated by a compaction measurement system that measures the amount of power required to move the rolling compactor along the surface of a work site. The compaction measurement system may determine the state of compaction of the material relative to an absolute scale or a maximum amount or degree of compaction. However, numerous variables may affect the results of the state of compaction, including whether a vibration system is used with the compactor, the composition of the material to be compacted, the thickness of the material to be compacted, the width of the compaction surface, the frictional or rolling resistance of the rolling compactor, the state of the tires of the rolling compactor, etc.

U.S. Pat. No. 9,207,157 describes a method and apparatus for use with a rolling compactor having a vibration system to determine the compaction performance of a material. The compaction performance may be determined as a function of additional factors including the inclination angle and speed of the compactor, the power loss from the compaction operation, and a vibration compensation factor based on vibration characteristics of the vibration system. The present disclosure is directed to improving the measured estimation of the state of compaction of a material produced by a rolling compactor.

### SUMMARY

One aspect of the present disclosure is directed to rolling compactor for compacting work material with respect to a work surface. The rolling compactor includes a machine chassis and a cylindrical drum rotatably connected to the machine chassis in rolling contact with the work surface. To propel the rolling compactor, a powertrain is connected to a propulsion device to apply motive power. To measure a gross power generated by the powertrain, a powertrain sensor is included and to measure a system temperature associated with one or more subsystems on the rolling compactor, a temperature sensor is included. An electronic controller can be configured to receive the gross generated power of the powertrain from the powertrain sensor and the system temperature from the temperature sensor and converts the system temperature to a temperature compensation factor. The electronic controller calculates an actual drive power applied to compaction from the gross generated power and the temperature compensation factor.

Another aspect of the present disclosure is directed to a method of compacting a work material by propelling a rolling compactor over a work surface having the work material. The gross generated power to propel the rolling compactor is determined and system temperatures of systems on the rolling compactor are measured by appropriate sensors. The system temperature is converted to a temperature compensation factor that the method can use to calculate an actual drive power applied to compaction gross generated power and the temperature compensation factor.

A further aspect of the present disclosure is directed to a compaction measuring system operatively associated with a rolling compactor. The compaction measuring system includes a powertrain sensor measuring the gross generated power generated and applied to move the rolling compactor with respect to a work surface and a temperature sensor measuring a system temperature associated with a subsystem of the rolling compactor. A data table may store a friction loss value associated with propelling the rolling compactor over the work surface. The compaction measuring system can also be associated with an electronic controller configured to convert the system temperature to a temperature compensation factor and to calculate an actual drive power applied to compaction from the gross generated power and the temperature compensation factor.

### BRIEF DESCRIPTION OF THE DRAWINGS

FIG. 1 shows a diagrammatic view of a mobile machine and particularly a rolling compactor in accordance with the present disclosure.

FIG. 2 shows a schematic view of exemplary drive systems, a vibration system, and an electronic controller for use with the machine of FIG. 1.

FIG. 3 shows an exemplary block diagram of compaction measurement system for use with the machine of FIG. 1.

FIG. 4 shows a flow diagram of a possible process, routine, or method for determining the state of compaction of a work surface during a compaction operation.

### DETAILED DESCRIPTION

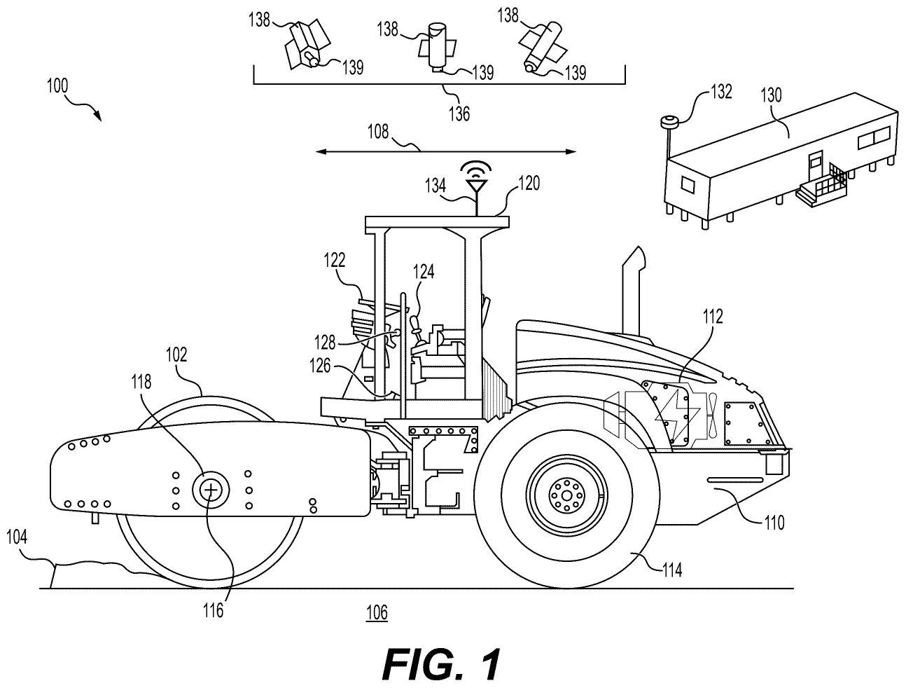

Now referring to the drawings, wherein whenever possible like reference numbers refer to like elements, there is shown in FIG. 1 a diagrammatic illustration of a mobile machine such as a self-powered, single-drum rolling compactor 100 having a single cylindrical drum 102 or roller for compacting work material 104 disposed over the work surface 106 of a worksite. Compaction of the work material 104 can be conducted by moving the rolling compactor 100 over the work surface 106 in a travel direction 108 in one or more passes so that the cylindrical drum 102 engages and rolls over the work material 104.

Compacting the work material 104 may increase its density and reduce its volume, or otherwise prepare the work material for subsequent use. Examples of work material 104 include asphalt, gravel, soil, sand, landfill trash, and other types of granular or aggregate material or composite that is capable of being compressed in volume. Compaction may be conducted at a construction site, a roadwork site, a mining site, a landfill, or any other area in which compression of the work material 104 is desired.

The rolling compactor 100 can include a machine frame 110 or chassis that functions as the load bearing structural framework to which the cylindrical drum 102 is rotatably attached. To propel the rolling compactor 100 over the work surface 106 in the travel direction 108, a drive system or powertrain 112 can be supported on the machine frame 110. The powertrain 112 includes a prime mover 146 responsible for generating motive power that can be transmitted through drivetrain components such as rotating shafts, gears, differentials, and the like to a final drive, which in the illustrated embodiment may be a deflectable or pneumatic tire 114. The pneumatic tire 114 is rotatably attached to the rear of the machine frame 110 and can be rotatably driven with respect to the work surface 106 by motive power from the prime mover to propel the rolling compactor 100 along the travel direction 108 in forward or reverse. Other examples of final drives for propelling the rolling compactor that may be used include additional cylindrical drums, continuous tracks, and the like. As described below, the prime mover 146 may utilize hydrostatic, electric, or mechanical techniques to generate power.

Powered rotation of the pneumatic tires 114 produces traction against the work surface 106 pushing the cylindrical drum 102 at the front of the machine frame 110 to roll over and compress the work material 104. The cylindrical drum 102 can be made of metal, plastic, or another rigid material and can have an elongate cylindrical shape oriented along a roller axis 116 that is orthogonal to the travel axis 108 of the rolling compactor 100. To facilitate the rolling motion, the cylindrical drum 102 can be attached and supported at the axial ends to the machine frame 110 by axle bearings 118. The axle bearings 118 allow relative rotation of the cylindrical drum 102 about the roller axis 116 with respect to the fixed machine frame 110.

The cylindrical exterior surface of the cylindrical drum 102 can be smooth to prevent the work material from adhering during the compaction operation. In another example, the cylindrical exterior surface can include protrusions or lugs that assist in crushing and compressing the work material 104, for example, when used to reduce material volume at a landfill. As described below, the cylindrical drum 102 can be associated with a vibration system that generates and applies vibratory forces against the work surface 106 to further compact and compress the work material 104. Another example of a rolling compactor 100 in accordance with the disclosure can be a double drum compactor in which the pneumatic tires 114 can be eliminated and rotating cylindrical drums 102 can be attached at both the forward and rearward ends of the machine frame 110.

To accommodate an operator who may control operation of the rolling compactor 100, an onboard operator station 120 can be located on the machine chassis 110 at an elevated location to provide visibility over the work surface 106. Located in the operator station 120 can be various controls and/or inputs with which the operator can interact to maneuver and operate the rolling compactor 100. For example, to steer and alter the travel direction 108 of the rolling compactor 100, a steering control 122 such as a steering wheel can be located in the operator station 120. To change the travel direction 108 between forward and reverse, or to change gear settings of a transmission incorporated in the powertrain 112, a gearshift 124 embodied as a joystick can be included in the operator station 120. The speed and travel velocity of the rolling compactor 100 can also be controlled by one or more depressible pedals 126 that an operator can actuate with their foot. Examples of pedals include an accelerator to increase the travel velocity and a brake to slow or stall the rolling compactor 100. To initiate operation, a key switch 128 or similar activation control can be included and used to startup the powertrain 112 and other systems from an unpowered state. The operator station 120 can also include various other readouts, dials, displays, and screens with which the operator can interface to communicate operational information regarding the activities of the mobile machine 100.

While the onboard operator stations 120 is intended to accommodate an operator for conventional manual operation, in other configurations, the rolling compactor 100 can be adapted for remote, semi-autonomous, or fully autonomous operation. Remote operation may also occur remotely wherein the operator is located off board the rolling compactor 100 and operation is controlled through a remote control transmitter and wireless communication techniques. For example, operation may be directed or guided from a remote command center 130 or an offboard workstation that is located at the worksite or elsewhere. Data communication can be transmitted between the rolling compactor 100 and the remote command center 130 via radiofrequency signals using a wireless network 132 arranged as part of a telematics system. To communicatively link to the wireless network 132, the rolling compactor 100 can include a transceiver 134 or wireless antenna extending from the machine chassis 110 and capable of sending and receiving wireless radio frequency data signals.

In autonomous operation, the rolling compactor 100 can operate responsively to information about the operating and environmental conditions of the worksite provided from various sensors by selecting and executing various determined responses to the received information. An autonomous rolling compactor 100 may include a computerized control system comprising hardware and software configured to make independent decisions based on programmed rules and logic. The control system uses sensor input about the machine environment, visions systems, etc., to control propulsion and steering in accordance with guidance controls, worksite or haul route information, and the assigned tasks or operations. In semi-autonomous operation, an operator either onboard or working remotely at, for example, the command center 130 may control the rolling compactor 100 to conduct some tasks and operations, while others are conducted automatically in response to information received from sensors.

To assist tracking the position and travel movements of the mobile rolling compactor 100 over the work surface 106, the rolling compactor 100 can be associated with a position determining system 136. The position determining system 136 can be realized as a global navigation satellite system (GNSS) or global positioning satellite (GPS) system. In the GNSS or GPS system, a plurality of manmade satellites 138 orbit about the earth at fixed or precise trajectories. Each satellite 138 includes a positioning transmitter 139 that transmits positioning signals encoding time and positioning information towards earth. By calculating, such as by triangulation, between the positioning signals received from different satellites 138, one can determine their instantaneous location on earth. In the present embodiment, the transceivers 134 on the rolling compactor 100 can be configured to also receive the positioning signals from the positioning transmitters 139.

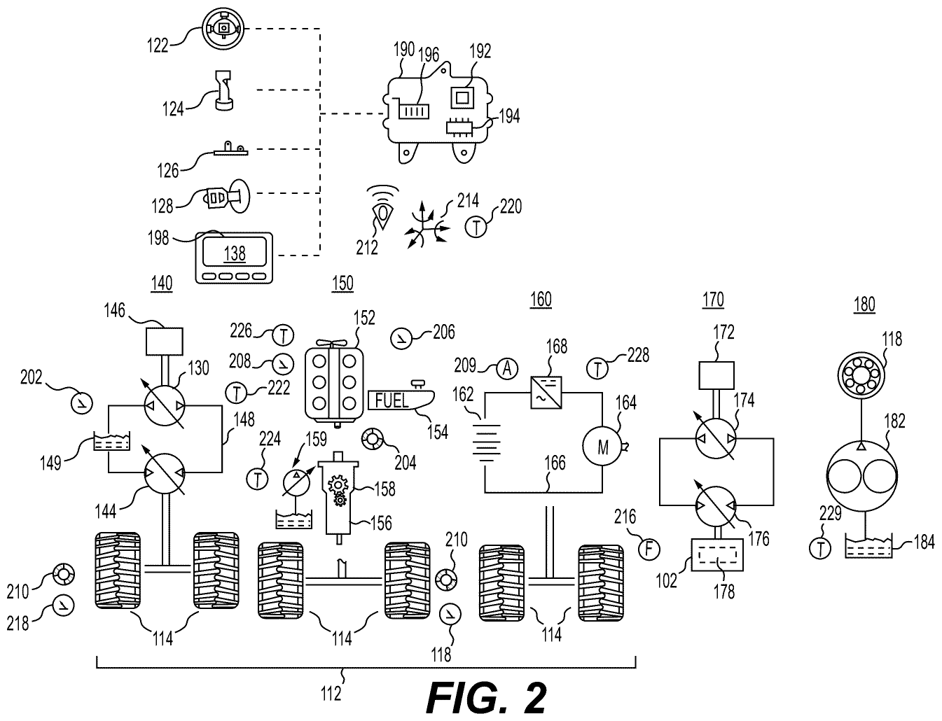

Referring to FIG. 2, and as indicated, the powertrain 112 can have different configurations and utilize different operating principles to propel the rolling compactor 100 over the work surface 106 during the compaction process. For example, the powertrain 112 can be a hydrostatic drive 140 that includes hydraulic pump 142 fluidly connected with a hydraulic motor 144 and arranged as part of a hydraulic circuit for the flow of pressurized hydraulic fluid there between. The hydraulic pump 142 can be operatively coupled to the output of a prime mover 146, such as internal combustion engine or an electric motor that generates motive power and torque, and the hydraulic motor 144 can be operatively coupled to drive the pneumatic tires 114 or another traction device functioning as the final drive. While the illustrated example shows a single combination of a hydraulic pump 142 and motor 144 arranged to drive the pneumatic tires 144, the hydrostatic drive 140 can include any number of pumps, motors and hydraulic circuits arranged to power the rolling compactor 100, including for example, powered rotation of the cylindrical drum 102.

The hydraulic pump 142 can be fluidly connected with the hydraulic motor 144 via a hydraulic line 148 or conduit, which may be embodied as flexible hoses or rigid tubing to accommodate the flow of pressurized hydraulic fluid. The hydraulic pump 142 can be a variable displacement pump with the fluid displacement or output adjusted by suitable controls. For example, hydraulic pump 142 can have a stroke-adjusting mechanism such as a swashplate, the position of which is hydro- or electro-mechanically adjusted to vary the output (e.g., a discharge pressure or rate) of the pump. The displacement of hydraulic pump 142 may be adjusted from a zero displacement position, at which substantially no fluid is discharged from the pump, to a maximum displacement position, at which fluid is discharged from the pump at a maximum rate and/or pressure. The displacement of the hydraulic pump 142 may be adjusted so the flow in the hydraulic line 148 can be in either direction and thus drive the rotational output of the hydraulic motor 144 in forward and reverse directions, depending on the direction of fluid flow.

The hydraulic motor 144 may be driven to rotate via a fluid pressure differential generated by the hydraulic pump 142 and transmitted through the hydraulic line 148. For example, the hydraulic motor 144 can include first and second chambers located on opposite sides of a pumping mechanism such as an impeller, plunger, or series of pistons. When the first chamber is filled with pressurized fluid from the hydraulic pump 142 via first hydraulic line 148 and the second chamber is drained of fluid returning to the hydraulic pump 142, the pumping mechanism is urged to move or rotate in a first direction (e.g., in a forward traveling direction). Conversely, when the first chamber is drained of fluid and the second chamber is filled with pressurized fluid, the pumping mechanism is urged to move or rotate in an opposite direction (e.g., in a rearward traveling direction). The flowrate of fluid into and out of the first and second chambers may determine the output velocity of the hydraulic motor 144, while a pressure differential across the pumping mechanism may determine the output torque or force.

The hydraulic motor 144 can be a variable displacement motor in which the response to the pressurized hydraulic fluid delivered by the hydraulic line 148 is adjustable by suitable controls. For example, the hydraulic motor 144 may have an infinite number of configurations or displacements. In another example, the hydraulic motor 144 may be a fixed and/or a multi-speed motor. In that configuration, the hydraulic motor 144 has a finite number of configurations or displacements (e.g., two) between which the motor may be shifted. The hydraulic motor 144 may thus operate as a fixed displacement motor with a plurality of distinct displacements.

To supply the hydraulic fluid that can be caused to flow between the hydraulic pump 142 and the hydraulic motor 144, the hydrostatic drive 140 can include a hydraulic reservoir 149 or fluid tank connected inline with the hydraulic lines 148. The hydraulic reservoir 149 can be vented to the atmosphere or can be sealed and pressurized. The hydraulic reservoir 149 can have any suitable fluid capacity. The hydraulic fluid can have appropriate properties and characteristics to function as a power transfer medium and is desirably a non-compressible fluid such as mineral oil or augmented water. The hydraulic fluid may have a suitably low freezing point to operate in cold environmental conditions, and may have a suitable viscosity to provide a lubricating benefit to the hydraulic components though which the fluid may flow.

In another example, the powertrain 112 can be a conventional engine drive 150 utilizing an internal combustion engine 152 to combust a hydrocarbon-based fuel and convert the latent chemical energy therein to mechanical power in the form of rotational motion and torque. The internal combustion engine 142 can be a gasoline burning spark ignition engine or may be a diesel burning compression ignition engine. To accommodate the hydrocarbon-based fuel, the internal combustion engine 142 can be fluidly connected with a fuel tank 154 or fuel reservoir. The fuel tank 154 can be configured to hold liquid fuel or, in some configurations, a pressurized gas. The fuel system can also include fuel pumps and fuel injectors to deliver the fuel from the fuel tank 154 to the internal combustion engine 152. The internal combustion engine 152 can be configured to operate within a range of rotational speeds, measured in RPM, an output torque measured in Newtons or foot-pounds that is delivered through a driveshaft protruding from the engine block.

To further adjust the speed and/or torque, the internal combustion engine 152 can be operatively connected to a mechanical transmission 156 that may also be referred to as a gearbox. The mechanical transmission 156 can include a plurality of intermeshing gear pairs or gear sets 158 that can be selectively engaged and disengaged by suitable controls. The individual gears of the gear sets 158 may have different diameters and different numbers of gear teeth protruding about their diameter. The diameters and tooth number can be such that when two different gears are intermeshed together, they will rotate at different rotational speeds. The different gear sets 158 can be arranged in fixed ratios and can be selectively engaged to adjust the rotational speed and, in an inverse relation, the torque transferred through the mechanical transmission 156. While the illustrated example includes fixed gear sets 158, other transmissions 156 may include different gear arrangements, such as planetary gears, or may be embodied as a hydrostatic transmission. The planetary or hydraulic transmissions may have a continuous or infinite ranges of gear ratios.

To selectively engage and disengage the different gear sets 158, the mechanical transmission 156 can include an hydraulic shifting system 159. The hydraulic shifting system 159 can utilize pressurized transmission fluid directed to and from fluid actuated clutches that are operatively associated with the different gear ratios. The pressurized transmission fluid can forcibly move the clutch plates into frictional engagement thereby engaging the associated gear set 158, and draining the transmission fluid from a clutch may release the clutch plates allowing slip and relative rotation between the opposing plates. The hydraulic shifting system 159 can include a separate pump and reservoir for the transmission fluid, although in some cases the hydraulic shifting system 159 can be combined with the hydrostatic system 140 and use fluid from the hydraulic reservoir 149.

In another example, the powertrain 112 can be configured as an electric drive 160 that utilizes electricity to generate motive power and drive the pneumatic tires 114 and other powered systems on the rolling compactor 100. To provide electric power, the electric drive 160 can include an electric power supply 162 such as an electric battery that performs a chemical reaction to generate electricity that can flow as current through electrical conductors like copper wires and cabling. The electric battery can include a plurality of individual cells assembled from the positive and negative electrodes and an electrolyte arranged to conduct the electrochemical reaction when electrically connected in a closed circuit with a load. The electric battery can be rechargeable and can be periodically recharged from an external power source such as the electrical grid. In another example, the electric power supply 162 can be a fuel cell that generates electricity by converting the chemical energy of a fuel such as hydrogen into electrical energy. In yet another configuration, the electrical power supply 162 can be an electric generator, which is similar to an electric motor and has an electromagnetic assembly that converts motive power into electrical power in the form of alternating electric current.

To convert electrical power to motive power for driving the pneumatic tires 114, the electrical drive 160 can include an electric motor 164 that is electrically connected to and receives electricity from the electric power supply 162 by electrical conductors 166 such as wires and cables. The electric motor 164 is an electromagnetic device including a plurality of conductive windings in which electricity flows to induce a rotating electromagnetic field. The electric motor 164 can also include a rotatable rotor having magnetic characteristics, such as permanent magnets or inductive coils, that respond to and magnetically couple with the rotating magnetic field. The rotor is therefore caused to follow and rotate with the magnetic field, thereby causing angular rotation of an associated motor shaft that can be connected to a load or drive. In an example, the electric motor 164 can be configured to operate on alternating current while the electric power supply 162, such as a battery, may provide direct current electrical power. To convert the direct current to alternating current, the electric drive 160 can include an power convertor 168 connected with the electrical conductors 176.

To improve compaction, the rolling compactor 100 can include a vibrator or vibration system 170 associated with the cylindrical drum 102. For example, in addition to the weight of the cylindrical drum 102 and the machine frame 110 being applied to the work surface 106 to apply compressive forces, a vibration system 170 within cylindrical drum 102 may operate to apply additional forces to the work material 104. As used herein, vibration system 170 includes any type of system that imparts vibrations, oscillations, or other repeating forces through the cylindrical drum 102 onto work surface 106.

The vibration system 170 may take any desired form. In an embodiment, the vibration system 170 may utilize a hydraulic drive system including a source of motive power 172 such as a vibration system engine or a vibration system electric motor, that is operatively connected to vibration system pump 174. The vibration system pump 174 may be operatively connected to power a vibration system motor 176 via hydraulic lines for the circulating of pressurized hydraulic fluid. The vibration system motor 176 may drive one or more rotatable shafts that are connected to and rotate one or more eccentrically mounted masses 178 within cylindrical drum 102 to create a vibrating or oscillatory force within the cylindrical drum that is imparted to the work surface.

Other manners of configuring the vibration system 170 are contemplated. For example, the source of motive power 172 may be omitted and vibration system pump 174 may be operatively connected to the internal combustion engine 152. Further, in other configurations, the eccentric masses 178 may be moved by mechanical, electrical, or electro-magnetic systems. In addition, in some embodiments, the masses 178 may be moved linearly back and forth, sliding along a shaft to produce oscillating forces, rather than eccentrically as part of a rotational system.

To lubricate the various joints and moving components of the rolling compactor 100, a lubrication system 180 can be provided. The lubrication system 180 can be configured to periodically direct a lubricant such as grease to the axle bearings 118 that support the cylindrical drum 102 for example. The lubrication system 180 can include lubricant pump 182 that is configured to pressurize and direct the viscous lubricant to the axle bearings 118 and other points of application through lubricant conduits such as rigid tubing or flexible hoses. The lubricant pump 182 may be configured as a rotary gear pump including internal meshing gears capable of displacing the highly viscous lubricant. The lubricant, such as grease, may be accommodated in a lubricant reservoir 184 such as a tank that can be periodically replenished.

To monitor and regulate operation of the rolling compactor 100, including the powertrain 112 and the vibration system 170, the rolling compactor 100 can be operatively associated with an electronic controller 190, also referred to as an electronic control module (“ECM”) electronic control unit (“ECU”), or just a controller. The electronic controller 190 can be a programmable computing device and can include one or more microprocessors 192 for executing software instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip. Although illustrated as a single component, in other embodiments, the functionality of the electronic controller 190 may be distributed among a plurality of separate components. In addition, the electronic controller 190 may be located onboard the rolling compactor 100 although in other embodiments some or all of the functionality may occur off board or remote from the compactor, for example, at the remote command center 130.

To store application software and data, the electronic controller 190 can include a non-transitory computer readable and/or writeable data memory 194, for example, read only memory (“ROM”), random access memory (“RAM”), EPROM memory, flash memory, or another more permanent storage medium like magnetic or optical storage. To interface and network with other operational systems, the electronic controller 190 can include an input/output interface 196 to electronically send and receive non-transitory data and information. The input/output interface 196 can be physically embodied as data ports, serial ports, parallel ports, USB ports, jacks, and the like to communicate via conductive wires, cables, optical fibers, or other communicative bus systems. To communicate with other operational systems, the electronic controller 190 can utilize any suitable forms of communication protocol for data communication including sending and receiving digital or analog signals synchronously, asynchronously, or elsewise.

To interact with an operator and receive operating commands, the electronic controller 190 can be communicatively associated with the various controls and/or inputs available in the operator station 120 or remotely. For example, the electronic controller 190 can be communicatively linked to the steering control 122 to monitor the travel direction of the rolling compactor 100 with respect to the work surface 106. The electronic controller 190 can also be communicatively linked with the gearshift 124 and can receive and process commands to change the settings of the mechanical transmission 156, for example, by shifting gear sets 158. The electronic controller 190 can also receive input from the one or more pedals 126 to command acceleration or braking of the rolling compactor 100. Active operation of the electronic controller 100 and the operational systems of the rolling compactor 100 can be initiated by the key switch 128 that powers on the connected devices.

The electronic controller 190 can also be associated with an operator interface device 198, also referred to as a human-machine interface (“HMI”). The operator interface device 198 can be an output device to visually present information to a human operator regarding operation of the rolling compactor 100. The operator interface device 198 can include a visual display screen 199 such as a liquid crystal display (“LCD”) capable of presenting numerical values, text descriptors, graphs, charts and the like regarding operation. The visual display screen 199 may have capacities such as a touchscreen to receive input from a human operator. In addition, the operation interface device 198 can include other input/output controls such as dials, knobs, switches, keypads, keyboards, mice, printers, etc. The operation interface device 198 may be located onboard the rolling compactor 100 located for instance in the operation station 120, may located be at the remote command center 130 or a plurality of operation interface devices 198 may be used in conjunction with the rolling compactor 100.

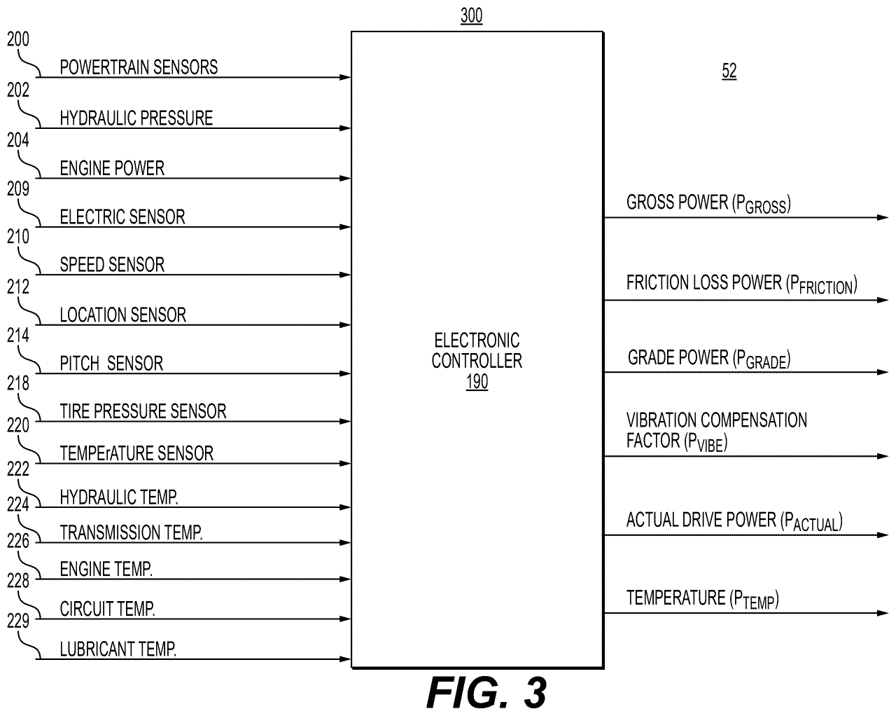

Referring to FIGS. 2 and 3, to receive data and information about the operation of the rolling compactor 100, the electronic controller 190 can be in electronic communication with a plurality of machine sensors that measure physical states and activities and transmit data signals indicative of those measurements and detections. The electronic controller 190 can be programmed to read and process the data signals, which may be embodied as voltage differences or current pulses transmitted via a communication bus or system network, for analysis and responsive regulation of the compaction operation. The machine sensors can be passive devices operatively associated with system components to monitor and make measurements of the relevant processes and actions. Examples of sensory techniques include electrical conditions such as voltage and conductivity, mechanical conditions including force and pressure sensors, chemical sensors, optical and/or acoustic sensors, etc.

For example, to determine the total and energy generated and consumed by the rolling compactor 100 during the compaction process, one or more powertrain sensors 200 can be associated with the powertrain 112. In the example of a hydrostatic drive 140, the powertrain sensor 200 may be a hydraulic pressure sensor 202 that is fluidly connected with the hydraulic circuit to measure the hydraulic pressure and/or fluid flowrate generated by the hydraulic pump 142. In the hydrostatic drive 140, the fluid pressure and flowrate produced by the hydraulic pump 142 and measured by the hydraulic pressure sensor 202 may be indicative of and correspond to the motive power delivered to the pneumatic tires 114 to propel the rolling compactor 100. Alternatively, in the hydrostatic drive 140, the powertrain sensor 200 can be arranged to measure motive power output generated by the prime mover 146 and delivered to the hydraulic pump 142.

In the example of the engine drive 150, the powertrain sensor 200 can be associated with the internal combustion engine 152 to measure data and information about the engine operation. For example, the powertrain sensor 200 can be an engine speed sensor 204 that measures the operating speed of the internal combustion engine 152. The engine speed sensor 204 can be a rotary encoder or a similar device that is operatively associated with the crankshaft to measure rotation in revolutions per minute. In addition to the engine speed sensor 204, powertrain sensor 200 can also include fuel sensors 206 and mass airflow sensors 208 that measure the flowrate and volume of fuel and air introduced to the internal combustion engine 152 and consumed in the combustion process. The electronic controller 190 can be programmed to process the measurements made by the engine speed sensor 204, fuel sensors 206 and mass airflow sensor 208 and possibly other information to compute or estimate the motive power produced and delivered by the internal combustion engine 152 through the combustion process in terms of torque or rotational force. The combination of engine speed sensors 204, fuel sensors 206 and mass airflow sensors 208 can be collective referred to as engine power sensors.

In the example of the electric drive 160, the powertrain sensors 200 can include an electrical sensor 209 such as voltmeter or ammeter to measure voltage or current in the electrical conductors 166. The characteristics and parameters measured by the electrical sensors 209 can be indicative of the electrical power transferred between the electric power supply 162 and the electric motor 164 and thus the quantity of motive force the electric drive 160 can generate. The electric sensor 209 can also monitor and measure the electromagnetic operation of the electric motor 164. Alternatively, in the electric drive 160, the powertrain sensor 200 can be a force sensor coupled to the output shaft of the electric motor 164 directly measuring the motive power generated in terms of torque or horsepower.

In addition to measuring the total power generated by powertrain 112 with the powertrain sensor 200, one or more velocity or speed sensors 210 can communicate with the electronic controller 190 to measure the velocity or speed of the rolling compactor 100 with respect to the work surface 106. The speed sensors 210 can be rotational sensors operatively associated with the pneumatic tires 114 to measure the speed of angular rotation of the tire which the electronic controller 190 can convert to ground speed based on the diameter of the tire. In another example, a location sensor 212 can be associated with the position determining system 136 to determine the geographic location of the rolling compactor 100. The electronic controller 190 can be programmed to process periodic location measurements made by the location sensor 212 to determine the velocity and ground speed of the rolling compactor 100 with respect to the work surface 106.

The compaction performance and power consumption of the rolling compactor 100 can be affected by the grade or inclination of the work surface 106 that may cause the rolling compactor to travel upwards or downwards with respect to the travel direction 108. To determine the inclination or pitch of the rolling compactor 100, one or more pitch sensors 214 can be attached to the machine chassis 110 and connected with the electronic controller 100. An example of a pitch sensor 214 can be an inertial measurement unit (IMU). The IMU can measure the applied forces caused by motion and/or acceleration of the rolling compactor 100 and can therefore determine its orientation and/or position. In an embodiment, the IMU can be sensitive to magnetic fields to obtain orientation with respect the magnetic field of the Earth. The information obtained by the IMU provides contextual reference and spatial associations about the physical arrangement and position of the rolling compactor 100, including the grade or inclination of the work surface 106 on which it travels.

Power consumption, compaction performance, and travel of the rolling compactor 100 may also be affected by the vibration system 170 associated with the cylindrical drum 102. To estimate the effects of vibration, a vibration sensor 216 can be associated with the vibration system 170. The vibration sensor 216 can be a force sensor or haptic sensor to measure the frequency and amplitude of the vibrations generated by the eccentric masses 178. The vibration sensor 216 can also be a pressure sensors that measures the hydraulic pressure between the hydraulic pump 174 and hydraulic motor 176 of the vibration system 170 and convert those measurements to vibration forces. Because travel and power consumption of the rolling compactor 100 may also be effected by the conditions of the pneumatic tires 114, tire pressure sensors 218 can be include that measure the air pressure therein.

Operation of the rolling compactor 100, including compaction performance, may be affected by external factors such as temperature. For example, the ambient temperature of the environment of the worksite may directly affect the operational performance of the rolling compactor 100. The operational subsystems of the rolling compactor 100, including the measurements and readings obtained by the sensors, may function differently in cold environments during winter and hot environments in summer. To measure and account for the ambient temperature, the electronic controller 190 can be in communication with one or more temperature sensors 220.

The temperature sensor 220 can be a thermometer and can utilize any suitable technique to measure temperature including the thermal expansion and contraction of fluids and metals. For example, the tendency of materials to expand and contract with temperature can be directed observed by the relative movement of a dial or indicator and calibrated to a temperature scale. Relatedly, the pressure or density changes of a material can be used to measure temperature. Other techniques include infrared sensors using electromagnetic radiation, changes in electrical conductivity and resistance, and any other suitable technique known in the art.

In an example, the temperature sensor 220 can be configured to measure the ambient temperature of the environment of the worksite in which the rolling compactor 100 is operating. For example, the temperature sensor 220 can be attached to the machine chassis 110 at an location exposed to the environment surrounding the rolling compactor 100. The temperature sensor 220 can also be arranged to measure the temperature of the work material 104 that is being laid and compressed on the work surface 106. For example, in an asphalt paving operation, the work material 104 may be at an initially elevated temperature to facilitate compaction into a paving mat over the work surface 106, and the temperature sensor 220 may make that measurement.

To obtain more specific temperature measurements regarding the operative subsystems of the rolling compactor, such as the powertrain, that are effected by temperature, one or temperature sensors can be directly associated with those systems. In the example of a hydrostatic drive 140, the hydraulic temperature sensor 222 can measure the temperature of the hydraulic fluid within the hydraulic circuit. For example, the hydraulic temperature sensor 222 can be located in the hydraulic line 148 or in the hydraulic reservoir 149 to measure the temperature of the hydraulic fluid flowing between the hydraulic pump 142 and hydraulic motor 144. In an embodiment, the hydraulic temperature sensor 222 can be operatively combined with the pressure sensor 202 associated with the hydrostatic drive 140.

In the example of the engine drive 150, a transmission temperature sensor 224 can be arranged to measure the operating temperature associated with the mechanical transmission 156. For example, the transmission temperature sensor 224 can be associated with the hydraulic shifting system 159 and may be in fluid contact with the transmission fluid flowing within the hydraulic shifting system 159, such as in a tank or reservoir for the transmission fluid. The transmission temperature sensor 224 can also be attached to or inside a casing of the mechanical transmission 156.

Temperature may also affect other components and devices of the engine drive 150. For example, combustion efficiency and the power produced by the combustion process is a direct result of the operation temperature of the internal combustion engine 152, so an engine temperature sensor 226 can be mounted to the engine block to measure the combustion temperature. Temperature of the fuel affects the combustion process and temperatures sensors can be located in the fuel tank 154 to measure fuel temperature.

In the example of an electric drive 160, a circuit temperature sensor 228 can be arranged to measure the temperature of the electric power supply 162 or the electric motor 164 that electromagnetically converts electrical power to torque. Temperature may affect the electrochemical processes of the battery serving as the electric power supply 162 or the conductivity of the motor windings of the electric motor 164 and the electrical conductors 166 connected thereto, and the circuit temperature sensor 228 can be measure and account for those external effects.

Temperature can also affect the lubrication subsystem 190 lubricating the moving loadbearing components and structures of the machine chassis 110. For example, the viscosity of the grease that lubricates the axle bearings 118 is a function of temperature and thus directly affects the tribological performance of the lubricant system 190. To measure the grease or lubricant temperature, a lubricant temperature sensor 229 can be included with the lubricant system 180 such as with the lubricant reservoir 184 or lubricant dispensing pump 182.

To determine or quantify the compaction of the work material 104 during a compaction operation as the rolling compactor moves over the work surface 106, the electronic controller 190 can be programmed with a compaction measurement system. Referring the FIG. 3, the compaction measurement system 300 can be an software application or firmware module associated with the electronic controller 190 to receive and process various inputs and generate one or more outputs that are indicative of the compaction state of the work material 104. The compaction measurement system 300 generally operates based on the concept that less power is required to move the rolling compactor 100 across a harder or more compacted work material 104 as compared to a softer or less compacted work material 104. By determining the actual drive power (P_{Actual}) applied by the rolling compactor 100 to compact the work material 104 via the cylindrical roller 102, a relative state of compaction of the work material may be determined.

The actual drive power (P_{Actual}) may be generally represented by the equation:

$${P}_{Actual} = {P}_{Gross} - {P}_{Grade} - {P}_{Friction} \qquad ( 1 )$$

where P_{Gross} is the gross or total amount of power used to propel the rolling compactor 100 along the work surface 106 (i.e., the amount of power lost or used during a compaction operation), P_{Grade} is the change in power due to the change in elevation or grade of the rolling machine 100, and P_{Friction} is the power lost due to friction associated with the rolling compactor 100 as it moves.

As depicted in FIG. 3, when executed by the electronic controller 190, the compaction measurement system 300 can receive information and data as data inputs from the various sensors and processes the information to generate data outputs indicative of the compaction operation and, in particular, about the state of compaction of the work material 104. The data inputs can be received as electronic data signals such as voltage or current differentials applied to input pins to the electronic controller. For example, to determine the total or gross generated power, P_{Gross}, produced by the powertrain 112, the compaction measurement system 300 can receive at a first communication node data signals from the powertrain sensor 200. For example, data signals indicative of the total gross power (PGross) can be sent from the hydraulic pressure sensors 202 associated with the hydrostatic drive 140, from the engine power sensors 204 associated with the conventional engine drive 150, and/or from the electrical sensors 209 associated with the electric drive 160

The compaction performance is substantially affected by the speed and velocity of the rolling compactor 100. Accordingly, the compaction measurement system 300 can receive measurements from the speed sensors 210 as data input signals applied to a node of the electronic controller 190. To provide the compaction measurement system 300 with information about the location of the rolling compactor 100, the location sensor 212 can be communicatively connected to a node of the electronic controller 190. If the pitch sensor 214, such as an inertial measurement unit (IMU), is included, the compaction measurement system 300 can receive pitch rate signals at another node of the electronic controller 190. Likewise, if the tire pressure sensors 218 are included, the tire pressure can be received at another node of the electronic controller 190.

Under some operating conditions, when operating the rolling compactor 100 together with the vibration system 170, the accuracy of equation (1) may also be reduced due to the effect of the vibration system 170 on the work material 104. For example, in some situations, operation of the rolling compactor 100 with the vibration system 170 has resulted in reduction in the calculation of the actual drive power (P_{Actual}). As a result, equation (1) may provide a first result when the vibration system 170 is in operation and a second result for the same physical location and work material characteristics when the vibration system 170 is off. As a result, a vibration compensation factor (P_{Vibe}) may be added to equation (1) to compensate for any changes due to the operation of the vibration system 170, as follows:

$${P}_{Actual} = {P}_{Gross} - {P}_{Grade} - {P}_{Friction} + {P}_{Vibe} \qquad ( 2 )$$

To obtain information for determining the vibration compensation factor P_{Vibe}, the compaction measurement system 300 can receive data input signals from the vibration sensor 216. For example, the vibration sensor 216 can measure and transmit information about the vibration forces being applied by the vibration system 170 through the cylindrical drum 102 to the work material 104 such as the vibration frequency and amplitude. The electronic controller 190 can be configured to evaluate and generate the vibration compensation factor P_{Vibe} based on the data received from the vibration sensor 216.

The compaction measurement system 300 can generate various output data signals indicative of the power utilization of the rolling compactor 100, and thus about the performance of the compaction process. The output data signals may be presented in terms of power like kilowatts or Newtons. For example, at a first output node, the electronic controller 190 may generate signals indicative of the total gross amount of generated power (P_{Gross}) used to propel the rolling compactor 100 over the work surface 106. The total or gross amount of generated power (P_{Gross}) can be obtained directly from the powertrain sensors 200 associated with the powertrain 112 representing the total power generated by the rolling compactor 100 and may account for any power or energy diverted to other subsystems via power takeoffs (PTO's) and the like.

At a second output node, the electronic controller 190 may generate signals indicative of the change in power (P_{Grade}) due to the change in pitch or grade of the rolling compactor 100. At a third node, the electronic controller 190 may generate signals indicative of the power lost (P_{Friction}) due to friction associated with the rolling compactor 100 as it travels with respect to the work surface 106. Friction loss (P_{Friction}) may include the power dissipated to overcome frictional resistance to movement of the power transferring components of the powertrain 112, for example. Frictional loss (P_{Friction}) may also include the rolling resistance associated with the work surface to be overcome to initiate propulsion of the rolling compactor 100.

To determine the friction loss characteristics (P_{Friction}) of the rolling compactor 100, a calibration process can be conducted in advance of actual operation at a worksite and the friction loss characteristics can be stored as values in the data memory associated with the electronic controller 190 for retrieval by the compaction measurements system 300. During calibration, a rolling compactor 100 is operated on a flat, hard calibration surface at various speeds without operating the vibration system 170 and the amount of power used when moving the rolling compactor at the different speeds is recorded.

More specifically, the rolling compactor 100 is positioned on a hard surface that does not deflect or compact under the weight of the compactor as would occur with a compactable work material 104. In addition, the surface upon which the rolling compactor 100 is positioned is flat so that the compactor is not going up or down a grade. As a result, the power required to move the rolling compactor 100 along such a calibration surface does not include any energy used to compact the work material nor is there any energy loss or gain due to the rolling compactor 100 moving up or down an incline. The power used as the rolling compactor 100 moves along the calibration surface thus accurately reflects only the friction losses of the compactor required to move the compactor with respect to a completely compacted reference work surface 106, such as the rolling resistance and other losses such as those caused by friction within the rolling compactor.

In one example, the friction losses may be determined by operating the rolling compactor 100 at a series of different speeds (e.g. 1 mph, 2 mph, 3 mph, 4 mph, etc.) while using the powertrain sensors 200 to determine the amount of power required to move the machine at each of those speeds. Friction losses may be extrapolated for values between the tested data points. If desired, the process may be repeated for different combinations of settings of the powertrain 112. The calibration process may be performed at any desired location such as at a facility at which the rolling compactor is manufactured. The friction loss characteristics generated be stored as a data library or lookup table within electronic controller 190.

If desired, rather than calibrate each rolling compactor 100 during assembly, standard or generalized friction loss characteristics may be developed such as by averaging data from a plurality of rolling compactors and such standard friction loss characteristics may be stored within data memory 194 of the electronic controller 190.

Referring to FIG. 3, at a fourth node, the electronic controller 190 may generate signals indicative of a vibration compensation factor (P_{Vibe}) used compensate for any changes in the compaction measurement system 300 due to the operation of the vibration system 170. At a fifth node, the electronic controller 190 may use the gross or total amount of generated power (P_{Gross}), the change in power (P_{Grade}) due to the pitch or inclination, friction power loss (P_{Friction}) and the vibration compensation factor (P_{Vibe}) to generate signals indicative of the actual drive power (P_{Actual}) used for compaction, and thus determine and display the state or degree of compaction of the work material 104.

As indicated, temperature affects the power utilization and thus the compaction performance of the rolling compactor 100. To account for temperature and changes in temperature, the compaction measurement system 300 can be configured to generate and use a temperature compensation factor that may be indicative of or represented by the motive power expended by the rolling compactor on account of temperature. The temperature compensation factor can be embodied as a data output P_{Temp} that is calculated by the electronic controller 190 from the various data input signals provided by the machine sensors, including the one or more temperature sensors 220. To receive temperature measurements for quantifying the power difference and effects due to temperature, the compaction measurement system 300 is operatively associated with the plurality of temperature sensors 220 that are communicatively connected with the electronic controller 190.

### INDUSTRIAL APPLICABILITY

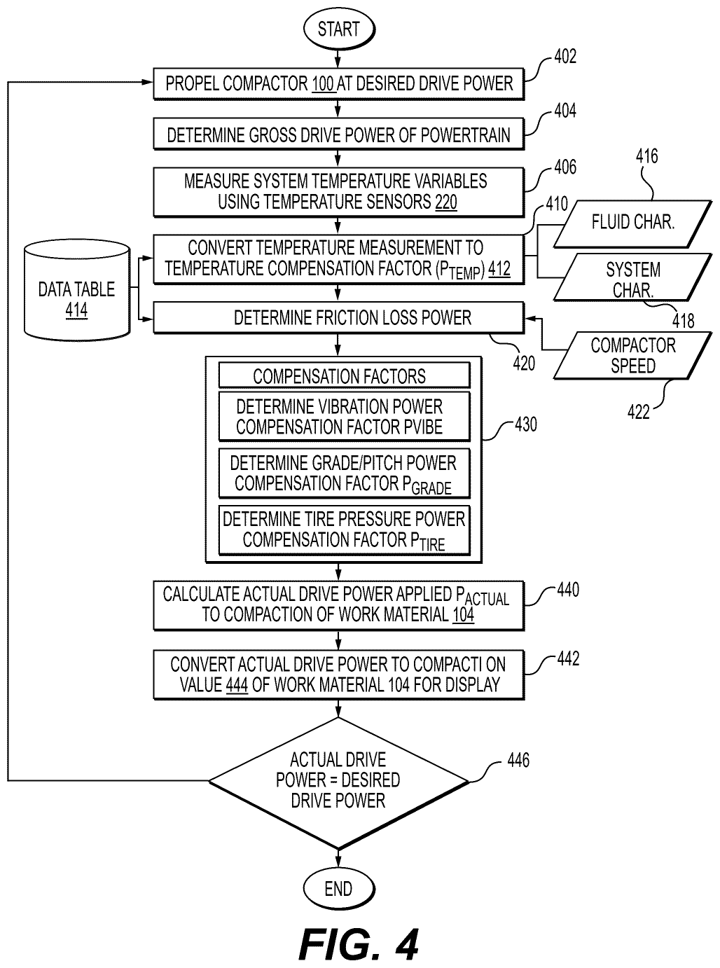

Referring to FIG. 4, with continued reference to the preceding figures, there is illustrated an embodiment of a possible routine, method, or process 400 executed by compaction measurement system 300 for estimating or measuring the state of compaction of a work material 104 that considers the effects of temperature on the powertrain 112 and other subsystems of a rolling compactor 100. The process 400 or method can be implemented as a non-transitory, computer-executable software program written in any suitable programming language and run on any suitable computer architecture utilizing one or more processors and peripheral devices. The functionality described with respect to FIG. 4 can be executed on a unitary device such as the electronic controller 190 onboard the rolling compactor 100, or may be distributed among different devices, and the order and arrangement of steps can be altered, modified, or expanded.

A compaction process 400 can be initiated in propulsion step 402 by propelling the rolling compactor 100 over the work surface 106 to roll the cylindrical drum 102 to compact and compress the work material 104. The related activities of propelling the rolling compactor 100 over the work surface 106 and compacting the work material 104 may consume substantially the total power generated by the powertrain 112, with minor exceptions for power diverted by power takeoffs and similar subsystems. In a drive power measurement step 404, the compaction measurement system 300 measures the total or gross generated power P_{Gross} produced by the powertrain 112, and which can be measured in units such as kilowatts or horsepower. For example, the total or gross drive power can be obtained directly from the hydraulic pressure sensor 202 associated with the hydrostatic drive 140, the engine power sensors associated with the conventional engine drive 150, and the electrical sensor 209 associated with the electrical drive 160.

To account for temperature on the compaction operation 400, a temperature measurement step or operation 406 may be conducted by the compaction measurement system 300 using one or more of the temperature sensors 220. For example, because temperature directly effects the viscosity and other physical characteristics of a fluid, the temperature measurement step 406 can measure the temperature of the hydraulic fluid circulating as a power transfer medium in the hydrostatic drive 140. For similar purposes in the conventional engine drive 150, the temperature measurement step 406 may measure the temperature of the hydraulic shifting system 159 associated with the mechanical transmission 156 or engine temperature. Since temperature affects electrical properties such as conductivity and resistance, in an electrical drive 160, the temperature measurement step 406 can measure the operating temperature of components like the electric power supply 162 and/or the electric motor 164.

To utilize the measured temperature obtained by the temperature measurement step 406 to assess compaction of the work material 104, the compaction process 400 includes a temperature-power conversion step 410. The conversion step 410 may convert the measured temperature into a temperature compensation factor 412, which may be presented in units of power like kilowatts and which may correspond to data output single P_{Temp} produced by the electronic controller 190.

For example, the compaction measurement system 300 can include or be associated with a data table 414 such as a lookup table stored in the data memory 194 of the electronic controller 190. The data table 414 can be an arrangement of searchable data that interrelates and enables the conversion between temperature and the corresponding quantitative measurement of power associated with P_{Temp}. Reference and conversion data and information in the data table 414 may be determined empirically in advance of the compaction process 400, for example, by a calibration process similar to that described for determining the friction loss P_{Friction}.

The conversion between temperature and power performance of the rolling compactor 100 and powertrain 112 in particular may be affected by other factors in addition to temperature. Accordingly, the compaction measurement process 300 can obtain and process these factors during the conversion operation 410. An example of additional factors can be the fluid characteristics 416 of the fluids associated with the powertrain 112. Fluid characteristics 416 may include viscosity and density, which are variables that change due to other external factors like temperature. For example, viscosity affects the ability of the hydraulic fluid in the hydrostatic drive 140 and the transmission fluid in the hydraulic shifting system 159 to transmit power. Similarly, the conversion step 410 can obtain system characteristics 418 such as performance specifications of the internal combustion engine 152 or the electric motor 164 for use in generating the temperature compensation factor 412.

The compaction process 400 can include a friction determination step 420 in which the compaction measurement system 300 determines the power losses P_{Friction} resulting, for example, from movement and travel of the rolling compactor 100 with respect to the work surface 106. The friction losses P_{Friction} can be determined by calibration of the rolling compactor 100 in advance of an actual compaction process 400 as described above and can be stored in and retrieved from the data memory 194 of the electronic controller 190. The friction losses P_{Friction} calculated by the friction determination step 420 may represent the baseline power consumption of the rolling compact 100 when operating in a non-compaction activity on a hard or completely compacted work surface 106.

The friction losses P_{Friction} can also be affected by other factors such as, for example, the travel velocity or speed of the rolling compactor 100 over the work surface 106. For example, at higher speeds, inertia and momentum may reduce the proportional relation between speed and friction losses P_{Friction}, in other words, sustaining propulsion of the rolling compactor 100 may require proportionally less power at higher speeds than at lower speeds. The friction determination step 420 can therefore obtain the compactor speed 422 from, for example, the speed sensor 210.

The compaction measurement system 300 can consider and account for several other factors affecting the power consumption of the rolling compactor 100 and are therefore included in the calculation of the actual drive power P_{Actual}. For example, the compaction process 400 can include a compensation step 430 or operation to analyze parameters and determine values to compensate for these additional factors. For example, as stated above, the vibration compensation factor may be used to adjust for use of vibration system 170. Under some operating conditions, use of the vibration system 170 may decrease the actual drive power (P_{Actual}) as determined by equation (1). Accordingly, a vibration compensation factor (P_{Vibe}) may be used to create consistency between actual drive power (P Actual) data regardless of whether the vibration system 170 is being operated.

In one example, a map of vibration compensation factors (P_{Vibe}) may be generated and stored within electronic controller 190 by operating the rolling compactor 100 on a specific area or location of a work surface 106, both with and without the vibration system 170 operating. The actual drive power (P_{Actual}) may be recorded together with the frequency and amplitude of the vibration system 170. This process may be repeated for a plurality of different frequencies and amplitudes. Other factors such as the type of work material 104, the speed of rolling compactor 100, and the state of compaction of the work material may also affect the vibration compensation factor (P_{Vibe}) and may be stored as part of the data map. It is contemplated that other factors may also affect the vibration compensation factor (P_{Vibe}).

In an alternate embodiment, the vibration compensation factor (P_{Vibe}) 432 may be determined based upon the pressure within the vibration system 170. More specifically, as the work material 104 is compacted and becomes stiffer, the hydraulic pressure within the vibration system 170 may increase. Vibration force sensor 216 may be operatively associated with the vibration system 170 to determine the fluid pressure of the vibration system 170, that can be correlated with a vibration compensation factor (P_{Vibe}). Accordingly, a data map vibration compensation factors (P_{Vibe}) corresponding to hydraulic pressure may also be generated and stored in data memory 194 of the electronic controller 190.

In another example, the compensation step 430 can determine the change in power P_{Grade} attributable to the incline or pitch of the rolling compactor 100 resulting from the grade of the work surface 106. The pitch or inclination of the rolling compactor 100 can be obtained by the compaction measurement system 300 from the pitch sensor 214. The pitch compensation P_{Grade} due to the incline can be determined as follows:

$${P}_{Grade} = m * g * V * sin ( α ) \qquad ( 3 )$$

where m is the mass of the rolling compactor 100, g is the force of gravity, V is the velocity of the rolling compactor 100, and a is the angle of the rolling compactor 100 relative to gravity as determined by the pitch sensor 214.

As another example, the compensation step 430 can determine the change in power P_{Tire} due to characteristics associated with the pneumatic tires 114 of the rolling compactor 100. For example, the power consumption of the rolling compactor 100 may vary depending on the tire pressure of the pneumatic tires 114. The tire pressure can be obtained by the tire pressure sensors 218 and processed by the electronic controller 190 can process the information to generate the tire pressure compensation factor P_{Tire}.

In a calculation step 440, the compaction measurement system 300 can calculate the actual drive power P_{Actual} applied directly by the rolling compactor 100 for compaction of the work material 104. For example, the electronic controller 190 can receive the values and compensation factors determined through the compaction process 400 and can apply an algorithm or equation that may be stored and retrieved from memory 194. The equation may take into consideration the temperature compensation factor P_{Temp} calculated in the temperature power conversion step 410. For example, the actual drive power P_{Actual} attributable to compaction may be determined according to the following equation:

$${P}_{Actual} = {P}_{Gross} - {P}_{Grade} - {P}_{Friction} + {P}_{Vibe} - {P}_{Temp} \qquad ( 4 )$$

To provide context for understanding the effectiveness or performance of compaction of the work material 104 by the rolling compactor 100, the compaction process 400 may include a compaction conversion step 442 that convert the actual drive power P_{Actual} to a compaction value 444. The compaction value 444 may be an arbitrary level or value that quantities the state or degree of compaction of the work material at the present stage of the compaction process 400. The compaction value 444 can presented as a numerical value or percentage and may be presentable on the HMI 190.

In an possible configuration, the compaction measurement system 300 can include a decision step 446 or operation to determine if adjustments should be made to the compaction process 400. For example, the decision step 446 can compare the actual drive power P_{Actual} applied to compaction with a desired power level that may represent the desired level of compaction of the work material. The desired power level may be correlated to the desired density or stiffness of the work material 104 for a particular state of the compaction process 400. If the decision step 446 determines the actual drive power is not equal to the desired drive operation, the operator or an autonomous system may continue the compaction operation if the decision step 446 determines the actual drive power P_{Actual} does equal the desired drive power, indicating the desired state of compaction of the work material has been achieve, the compaction management system 300 can terminate the compaction process 400.

The compaction management system 300 considers the effect temperature will have in determining the state of compaction of the work material and can provide a more accurate measurement. For example, when the rolling compactor 100 is initially started from a powered down state, the system temperatures of the operative subsystems is low especially during winter or in cold environments. Fluids will have lower viscosity and thus higher resistance to applied forces and the cold engine 152 may take longer to achieve hotter running temperatures. Conversely, in hotter climate or during the summer, batteries 162 and/or electric motors 164 may be characterized by increased resistances and transmit less power. The temperature compensation factor 412 accounts for these affects. Moreover, as the rolling compactor warms up during use, repetitive operation of the compaction process 400 which may be a closed loop accounts for the changing temperatures and related effects, such as changing viscosity of the hydrostatic drive 140 and conductivity of the electric drive 160.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A rolling compactor for compacting work material with respect to a work surface, the rolling compactor comprising:
a machine chassis;
a cylindrical drum rotatably connected to the machine chassis in rolling contact with the work surface;
a powertrain operatively connected to a propulsion device for applying motive power to move the rolling compactor with respect to the work surface;
a powertrain sensor associated with the powertrain to measure a gross generated power from the powertrain;
a temperature sensor; and
an electronic controller configured to receive a gross generated power of the powertrain from the powertrain sensor; receive a system temperature from the temperature sensor; convert the system temperature to a temperature compensation factor; and to calculated an actual drive power applied to compaction from the gross generated power and the temperature compensation factor.

2. The rolling compactor of claim 1, wherein the electronic controller is further configured to obtain a friction loss value associated with power loss due to propelling the rolling compactor over the work surface.

3. The rolling compactor of claim 2, wherein the friction loss value is determined by calibration.

4. The rolling compactor of claim 3, wherein the electronic controller is further configured to determine a power compensation factor due to pitch of the rolling compactor received from a pitch sensor.

5. The rolling compactor of claim 4, wherein the electronic controller is further configured to determine a power compensation factor due to a tire characteristic received from a tire pressure sensor.

6. The rolling compactor of claim 1, wherein the powertrain is a hydrostatic drive and the temperature sensor is hydraulic temperature sensor measuring temperature of a hydraulic fluid.

7. The rolling compactor of claim 1, wherein the powertrain includes an internal combustion engine and the temperature sensor is an engine temperature sensor.

8. The rolling compactor of claim 1, wherein the powertrain includes a mechanical transmission and the temperature sensor is a transmission sensor measuring temperature of a transmission fluid.

9. The rolling compactor of claim 1, wherein the powertrain is an electric drive and the temperature sensor is a circuit temperature sensor measuring temperature of the electric drive.

10. The rolling compactor of claim 1, further comprising a lubrication subsystem providing lubricant to one or more axle bearings of the machine chassis, and the temperature sensor is a lubricant sensor measuring temperature of the lubricant.

11. The rolling compactor of claim 1, wherein the electronic controller is further configured to convert the actual drive power to a compaction value.

12. The rolling compactor of claim 1, wherein the electronic controller calculates the actual drive power using the equation P_{Actual}=P_{Gross}−P_{Friction}−P_{Temp}.

13. A method of compacting a work material comprising:
propelling a rolling compactor over a work surface having the work material;
determining a gross generated power produced by a powertrain to propel the rolling compactor over the work surface;
measuring a system temperature using a temperature sensor associated with subsystem of the rolling compactor;
converting the system temperature to a temperature compensation factor; and
calculating an actual drive power applied to compaction gross generated power and the temperature compensation factor.

14. The method of claim 13, further comprising determining a friction loss value associated with power loss due to propelling the rolling compactor over the work surface.

15. The method of claim 14, wherein the friction loss value is determined by calibration.

16. The method of claim 13, wherein the powertrain is a hydrostatic drive and the temperature sensor is a hydraulic temperature sensor measuring temperature of a hydraulic fluid.

17. The method of claim 13, wherein the powertrain includes a mechanical transmission and the temperature sensor is a transmission sensor measuring temperature of a transmission fluid.

18. The method of claim 13, wherein the powertrain is an electric drive and the temperature sensor is a circuit temperature sensor measuring temperature of the electric drive.

19. The method of claim 13, further comprising a lubricant temperature sensor to measure temperature of a lubricant applied by a lubrication system to one or more axle bearings of the rolling compactor.

20. A compaction measuring system operatively associated with a rolling compactor comprising:
a powertrain sensor measuring a gross generated power applied to move the rolling compactor with respect to a work surface;
a temperature sensor measuring a system temperature associated with a subsystem of the rolling compactor;
a data table storing a friction loss value associated with propelling the rolling compactor over the work surface; and
an electronic controller configured to convert the system temperature to a temperature compensation factor and to calculated an actual drive power applied to compaction from the gross generated power and the temperature compensation factor.
